(19) United States
(12) Patent Application Publication
(10) Pub. No.: US 2018/0198620 A1
(43) Pub. Date: Jul. 12, 2018

(54) SYSTEMS AND METHODS FOR ASSURING DATA ON LEASED COMPUTING RESOURCES

(71) Applicant: Raptor Engineering, LLC, Belvidere, IL (US)

(72) Inventor: Timothy Raymond Pearson, Boone, IL (US)

(21) Appl. No.: 15/868,269

(22) Filed: Jan. 11, 2018

Related U.S. Application Data
(63) Continuation of application No. 62/445,121, filed on Jan. 11, 2017.
(60) Provisional application No. 62/486,828, filed on Apr. 18, 2017.

(51) Int. Cl. H04L 9/32; H04L 9/08; G06F 21/62

(52) U.S. Cl. CPC H04L 9/3234; H04L 9/3247; G06F 9/45533; G06F 21/6245; H04L 9/0897

(57) ABSTRACT

Embodiments described herein disclose systems and methods for ensuring integrity of shared computing resources against potentially malicious activities. Embodiments may reassign security operations and procedures away from managing entities and the physical owner of the shared computing resources, and allocate the security operations and procedures to a trusted hardware module which may be authenticated and/or verified by a client side device.

### CROSS-REFERENCE TO RELATED APPLICATIONS

This application claims a benefit of priority under 35 U.S.C. § 119 to Provisional Application Nos. 62/445,121 filed on Jan. 11, 2017 and 62/486,828 filed on Apr. 18, 2017, which are fully incorporated herein by reference in its entirety.

### BACKGROUND INFORMATION

### Field of the Disclosure

Examples of the present disclosure are related to systems and methods for assuring integrity and confidentiality of data on leased computing resources through public data.

### Background

Cloud computing, or more generically Hardware as a Service (HaaS), is internet-based computing that provides shared processing resources and data to computing devices on demand. This enables on-demand access to a shared pool of configurable computing resources that can be rapidly provisioned and released with minimal effort. With the advent of inexpensive, widespread, and high speed data links, cloud computing and other forms of leased computing resources have increased in popularity. These computing resources are typically located in a single location or a collection of strategic locations worldwide, wherein multiple separate clients lease part of the computing resources. Traditionally, the owner or operator of the physical facilities and physical machines for the leased computing resources has full administrative access to the computing resources. Additionally, these operators can gain full administrative access to any client computing resources with well-established and reliable methods.

However, this access allows exfiltration of private data, silent modification, or other undesirable operations on data stored on leased computing resources. In turn, providers of leased computing resources that are physically positioned in regions without strong data privacy law are unable to guarantee the confidentiality of data located on the leased computing resources within these regions or at all. Thus, operators associated with leased computing resources and/or administrative headquarters positioned at regions with weaker data privacy laws are at a significant competitive disadvantage when compared to operators in regions with stronger data privacy laws.

Currently, there are few systems and methods to protect data stored on leased computing resources outside of the operators or service providers. Most service providers rely on a combination of physical security to the machines hosting the leased computing resources and the previously assumed low likelihood of being coerced into leaking data on the leased computing resources. Certain industries handling sensitive material require dedicated bare metal access for systems handling personally identifiable information (PII). However, this only provides minimal additional resistance to coerced data extraction by the facility and/or machine owner.

Accordingly, needs exist for more effective and efficient systems and methods for ensuring the integrity of shared computing resources against potentially malicious activities, wherein accessing data stored on leased computing resources requires verification via data stored on client side devices.

### SUMMARY

Embodiments described herein disclose systems and methods for ensuring integrity of shared computing resources against potentially malicious activities. Embodiments may reassign security operations and procedures away from a managing entity, such as a physical owner or platform vendor, of the shared computing resources, and co-allocate the security operations and procedures to a trusted hardware module, wherein the authenticity of the trusted hardware module may be verified with a client side device. In implementations, the trusted hardware module may be a hardware security module that is stored at the shared computing resources, which is a remote location from the client side device

In embodiments, reproducible builds with publically accessible sources may be utilized to create one or more minimum trusted images (MTIs) and/or a trusted network interface images (TNII), which are stored within a public access area associated with a remote computing provider. Each image may include a boot and/or runtime firmware, kernel, and user space software required to execute one or more virtual machines, with the ability to access the temporal and/or terminal state of the running virtual machines removed from the firmware, kernel, and user space tools.

A hash of a running image may be queried by the lessee of shared computing resources via a client side device during or before the startup of the virtual machine. During or before the virtual machine startup, the client side device may be configured to implement a cryptographic nonce based verification, wherein the cryptographic nonce is signed by a private key generated by the underlying image stored within the trusted hardware module on the leased computing resources on a remote computing device. A trusted hardware module on the remote computing device may store private keys for a communication channel used for the client side device to control the virtual machine. This may prevent a “man in the middle” attack on the communication channels.

In embodiments where bare metal severs are leased, a trusted network interface image (TNII) may be utilized on the server's bare metal computer along with private keys stored on the trusted hardware module. These may enable the communication channel between the client side device and the bare metal computer. The TNII may be generated from a reproducible build with publically accessible sources, and be configured to allow the lessee access to the trusted hardware module for cryptographic nonce-based verification of underlying security operations associated with startup firmware.

Embodiments may also utilize an optional open-source, client-side utility to generate a nonce based verification of the trusted hardware module's operations. The utility may generate nonce values and verify the validity of the trusted hardware module cryptographic response using the generated nonce value, in addition to displaying and/or verifying that a public key that the trusted hardware module has used to generate the cryptographic response.

In embodiments, multiple users associated with client side devices may be present whenever a new trusted hardware module enabled system is provisioned with a programmed image and a new public key is recorded. This may create an audit trail, which may be useful to prevent rogue tampering. For example, if a security officer is operating under external coercion. In embodiments, trusted staff and/or non client-associated outside observers may replace or augment part or all of the users associated with client side devices during system provisioning.

In embodiments, a table of all active trusted hardware module public keys may be published on a public website, while the private keys remain private and inaccessible by the client side device. The table with the public keys may be cryptographically signed by at least one of the security officers. In other embodiments and for more security, the table may include links to the full source code used to reproducibly build the trusted hardware module's image, along with the cryptographic hash of the trusted hardware module's image associated with the public key, the date of the programming/key generation of the trusted hardware module, and the names and/or digital signatures of the security officers and/or external observers auditing the system. The table may also include statements that all the data provided is true and accurate, and has not been altered. These methods and systems may prevent or reduce the likelihood of insertion of untrustworthy public keys into the table. Thus, preventing targeted compromise of specific leased computing resources.

Embodiments are configured to allow remote computing resource providers or other hardware as a service provides to reasonably guarantee the integrity and confidentially of a lessee's data on leased machines or leased virtual machines by rendering the data inaccessible to the facility owner, facility operator, and/or platform vendor(s) without the lessee's knowledge. This may allow remote systems to be safely used in sensitive industries. For example, when handling personally identifiable information (PII), which may lower costs associated with retaining confidentiality and integrity of data.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a topology for a system configured to assure the integrity and confidentiality of leased computing resources and leased virtual computing resources at one or more central locations, according to an embodiment.

FIG. 2 depicts a detailed system configured to assure the integrity and confidentiality of leased computing resources and leased virtual computing resources at one or more central locations, according to an embodiment.

FIG. 3 illustrates a method for assuring integrity and confidentiality of leased computing resources and leased virtual computing resources at one or more central locations, according to an embodiment.

FIG. 4 illustrates a method for assuring integrity and confidentiality of leased computing resources and leased virtual computing resources at one or more central locations, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

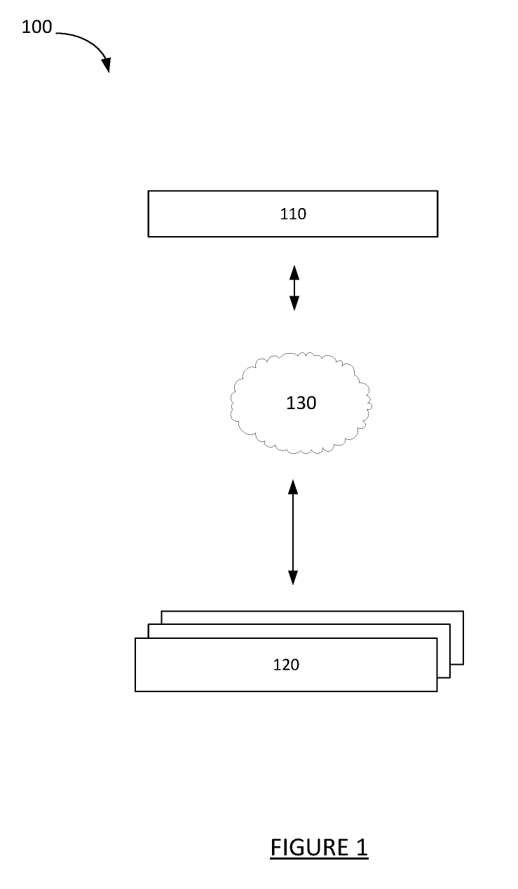

Turning now to FIG. 1, FIG. 1 depicts a topology for a system 100 configured to assure the integrity and confidentiality of leased computing resources and leased virtual computing resources at one or more central locations, according to an embodiment. System 100 may include remote computing resource(s) 110, at least one client side device 120, and network 130.

Remote computing provider 110 may be any type of internet or remote based computing system that provides shared computer processing resources and data to computers and other devices on demand. Remote computing provider 110 may enable ubiquitous, on-demand access to a shared pool of configurable computing resources, such as computer networks, servers, storage, applications, and computing services. The shared pool of configurable computing resources may be rapidly provisioned and released with minimal management efforts. The configurable computing resources may enable storage solutions to store and process data associated with client side device 120 to enable a user associated with client side device 120 to access data remotely. In embodiments, the configurable computing resources associated with remote computing provider 110 may be owned and controlled by a third party, which is independent from users associated with client side device 120.

Remote computing provider 110 may be a computing device, such as a general hardware platform server configured to support mobile applications, software, and the like executed on client side device 120. Remote computing provider 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and/or bare metal control systems, released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), Hardware as a Service (“HaaS”), and deployment models (e.g., private cloud, community cloud, public cloud, hybrid cloud, etc.). Remote computing provider 110 may include any combination of one or more computer-usable or computer-readable media. For example, Remote computing provider 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Client side device 120 may be a smart phone, tablet computer, laptop computer, personal data assistant, or any other type of computing device with a hardware processor that is configured to process instructions and connect to one or more portions of network 130. Client side device 120 may include processors, communication devices, memory, firmware, security modules, etc.

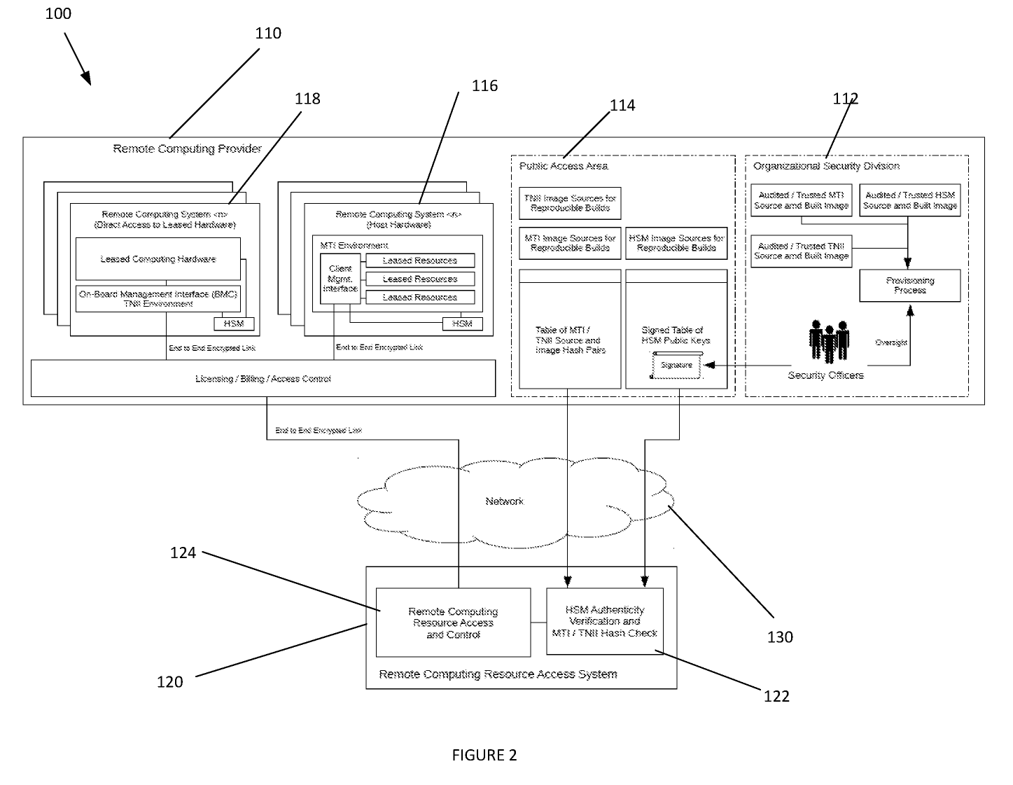

FIG. 2 depicts a detailed system 100, according to an embodiment. As discussed herein, system 100 may be configured to prevent associates for remote computing provider 110 to have direct, physical access to the data stored within the shared computing resources without a user associated with client side device 120 being aware of the access. System 100 may also be configured to prevent associates for remote computing provider 110 to have logical, firmware, or software based access to the data stored within the shared computing resources without a user associated with client side device 120 being aware of the access.

Remote computing provider 110 may be a cloud services provider configured to lease computing resources and/or hardware to client side device 120 over network 130. Remote computing provider 110 may include an organization security 112, a public access area 114, host hardware 116, and leased computing hardware 118.

The organization security 112 may include a plurality of security officers that are responsible for the provisioning process of leased computing resources and hardware, wherein private keys for HSM 510 and the corresponding public keys are generated during the provisioning of the leased computing resources and hardware. The officers may also be responsible for verifying secured and trusted images of firmware and other software are the actual images programmed into the remote computing provider 110. Utilizing images associated with the hardware security module (HSM), a minimum trusted image (MTI), and/or trusted network interface image (TNII), the images may be programed into a server associated with remote computing provider 110 in a secured environment, and the public key(s) of the HSM recorded and certified with the security officer's signatures. In embodiments, the images may include the boot/runtime firmware, kernel, and user space software required to execute one or more virtual machine with any ability to access the temporal state, such as the RAM, cache, CPU state, etc. of the remote computing provider 110. The officers may verify that the HSM, MTI, and/or TNII image was programed into the server, and that the HSM has generated a corresponding private public key pair. The officers may also certify the public key via a cryptographic signature. In embodiments, a similar process may be performed for a MTI, TNII, and/or a hardware security module image (HSM). In embodiments, external observers may oversee this process and certify, e.g. through cryptographic signature or other public statement, that the provisioning process was executed according to organizational policy and/or external requirement(s).

The public access area 114 of remote computing provider 110 may be utilized to publish public data on a public site, and create reproducible builds with publically accessible sources which are loaded into remote computing provider's 110 computing resources. Public access area 114 may include TNII image sources for reproducible builds, MTI image sources for reproducible builds, and HSM image sources for reproducible builds. For example, the table within public access area 114 may include a link to the full source code used to reproducibly build the images, wherein the table may be manually generated or automatically assembled from submitted information. The public access area 114 may also include a table of pairs MTI/TNII source unique identifiers and cryptographic hash of the MTI/TNII associated with the HSM public key, the date of the MTI/TNII programming and HSM key generation, and the names of the security officers auditing the images and key generations. The public access area 114 may also include a table of HSM public keys along with the officer's cryptographic signatures. The table may also include a statement that all data provided is true and accurate, and has not been altered in any way. These methods are required to prevent insertion of rogue (untrustworthy) public keys into the table. Thus, preventing targeted compromise of specific leased computing resources on remote computing provider 110. In embodiments, the tables may be utilized by a client side device 120 to parse a cryptographic hash along with a cryptographic nonce generated by client side device 120 to determine if client side device 120 has established secure access to untampered leased computing resources. In embodiments, external observers may certify individual machines, and their signatures may be published alongside the security officers' signatures in the HSM key table, wherein the HSM key table includes public keys. Thereby, establishing an external web of trust from client side device 120 in conjunction with, and complementary to, the internal root of trust. Because each image is examined at provisioning by one or more individuals, and each individual has attested to the fact with a digital signature within public access area 114, a client may freely select which individuals to trust when selecting a leased computing resource to request remote attestation from.

Host hardware 116 may be configured to implement an MTI environment based on the MTI or other image. The MTI environment may include a client management interface and leased resources, which may be accessible after connection by and attestation to the client device. In embodiments, the MTI environment may include an operating system based on the MTI, which may be stored in the platform ROM and/or other persistent storage of remote computing provider 110.

Leased computing hardware 118 may be configured to implement the TNII (or other image) on remote computing provider 110. In embodiments, the TNII may be utilized on remote computing provider's 110 server bare metal system with private keys to establish a communication channel between client computing device 120 and remote computing provider 110, which may occur through an end to end encrypted link.

In embodiments, host hardware 116 and/or leased computing hardware may include a trusted hardware module, such as a hardware security module (HSM) 510. HSM 510 may be configured to generate and store a private and public key pair at initial provisioning, and may be utilized for firmware verification and establishing communications with client computing device 120. HSM 510 may be configured to store the private keys and public keys generated at runtime by or otherwise associated with the images. In implementations, HSM 510 may be configured to receive a nonce from client side device 120, wherein the nonce may include other data with the authentication request for which HSM 510 must return authenticated data. Responsive to receiving the nonce, HSM 510 may assemble response data, HSM 510 may form a cryptographic signature for the nonce using its internal private key, and transit the response data that includes a cryptographic signature to client side device 120.

Client side device 120 may include hardware security module (HSM) verifier 122 and remote computing resource access and control 124. In embodiments, client side device 120 may be configured to request access to leased computing resources or hardware that are available. A user associated with client side device 120 may request leased computing resources and/or hardware based on attestations of trusted officers within public access area 114. In implantations, the user may only select leased computing resources and/or hardware with attestations from known and/or trusted officers.

HSM VERIFIER 122 may be a physical computing device that is configured to safeguard and manage digital keys for authentication and cryptographic processing. HSM VERIFIER 122 may be configured to download, view, or parse the public table with public keys associated with public access area 114. For example, HSM VERIFIER 122 may download the table of MTI/TNII hash pairs, and cryptographically signed table of HSM public keys along with the cryptographic signatures of the officers, and verify the cryptographic signatures. HSM VERIFIER 122 may utilize the public tables to authenticate access and control 124.

In implementations, HSM VERIFIER 122 may be configured to form a connection with host hardware 116 or leased hardware 118 by transmitting a cryptographic nonce to remote computing provider 110. The cryptographic nonce may be random data, such as a string of random numbers or characters, generated by client side device 120, which may include request data for which signed response data from HSM 510 is desired, such as a request for current firmware hashes and system status. HSM 510 may utilize the cryptographic nonce and the current hashes of the firmware and/or MTI/TNII image(s) to reply to the attestation request with a signed response. In implementations the signed response from HSM 510 is based on the internal private key generated by the firmware of HSM 510 at provisioning time, and that is stored within HSM 510. In response to receiving the signed response with the cryptographic signature, HSM VERIFIER 122 may utilize the public table located within public access area 114 to verify that the cryptographic signature of the nonce and the hashes correspond with an entry in the public table. HSM VERIFIER 122 may also verify the signed firmware hashes and system state before allowing connection to the remote computing resources.

In implementations, the client side device 120 may utilize the table of public keys within public access area for client side analysis. For example, client side device 120 may utilize the table of public keys to determine which individuals or group of individuals they desire to trust, wherein an operator of client side device 120 may view the table and select remote computing resources that were provisioned by trustworthy, known, desirable, etc. individuals. This may limit spoofing on a given remote computing resources because the private keys associated with HSM are automatically generated during provisioning of the remote computing resources, and are not externally communicated over an unsecure connection.

Access and control 124 may be configured to transmit communications over network 130 to remote computing provider 110. For example, once the remote computing resources have been verified, access and control 124 may implement a connection to the remote computing resources and transmit encryption keys or other sensitive data.

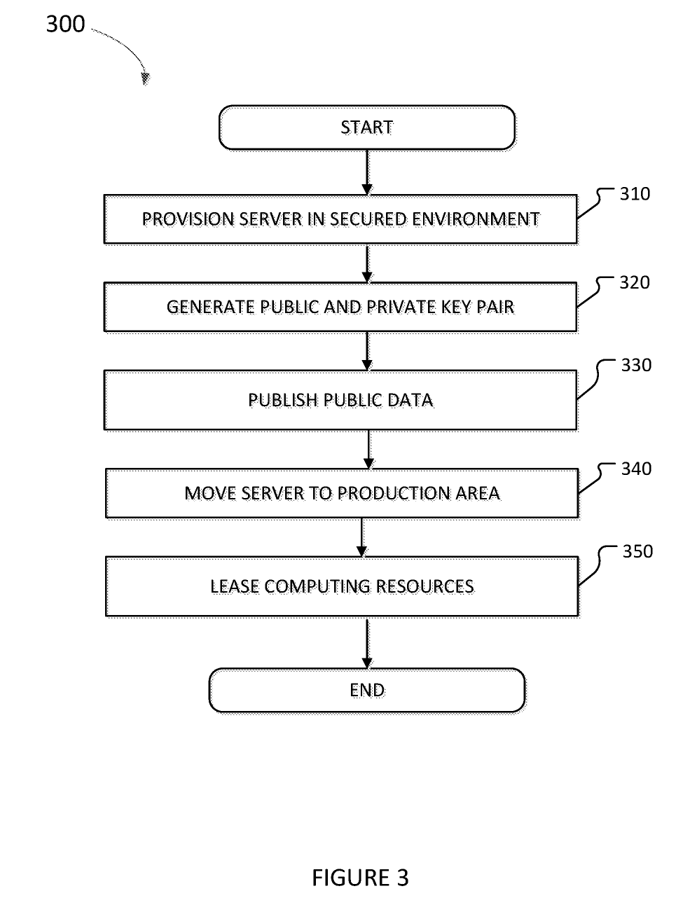

FIG. 3 illustrates a method 300 for assuring integrity and confidentiality of leased computing resources and leased virtual computing resources at one or more central locations, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, a server with associated trusted hardware module, such as an HSM, may be provisioned in a secured, remote, environment, and a secured and trusted image may be programed into the associated trusted hardware module. Additionally, a plurality of security officers associated with an organization may verify that the secured and trusted image is the actual image programed into the trusted hardware module. This verification may occur via standard business practices for verification that a trusted image is programed into the trusted hardware module.

At operation 320, the secured and trusted image may generate a public and private key pair, which may be stored within the trusted hardware module. The public key may be made available for view and use by the security officers once key pair generation is complete.

At operation 330, the trusted hardware module public key for the server may be certified, published, and inserted into a key table. The table may also include a cryptographic hash of the trusted hardware module image and cryptographic signatures of the preceding data, which are made by the security officers. These signatures may include legal statements of truth and data validity, and may be utilized as protections against national security letters (NSLs) or other legal instruments, which do not allow an officer to be compelled to sign something that is not true. By detailing the state of the system publically via the table, the officers are attesting that the table is accurate. Thus, minimizing the risk of the data on the server from being tampered with.

At operation 340, once the server is provisioned, the server may be moved to the production area, where an operating system may be set up. Additionally, a minimally trusted image (MTI) and/or trusted network interface image (TNII) may be stored into the ROM of the server. Because the MTI and TNII are created utilizing public sources, there may be an audit trail where a hash of the images may be verified.

At operation 350, a virtual machine associated with the server may be leased. The virtual machine may be leased by provisioning computing resources associated with the server to a client side device. Further, the virtual machine may be leased responsive to the HSM receiving a nonce from a corresponding client side device. The HSM may utilize a locally stored private key to cryptographically sign the nonce, and transmit the cryptographic signature to the client side device. Based on the cryptographic signature and the published public key data, the client side device may establish a connection and request and/or access a virtual machine.

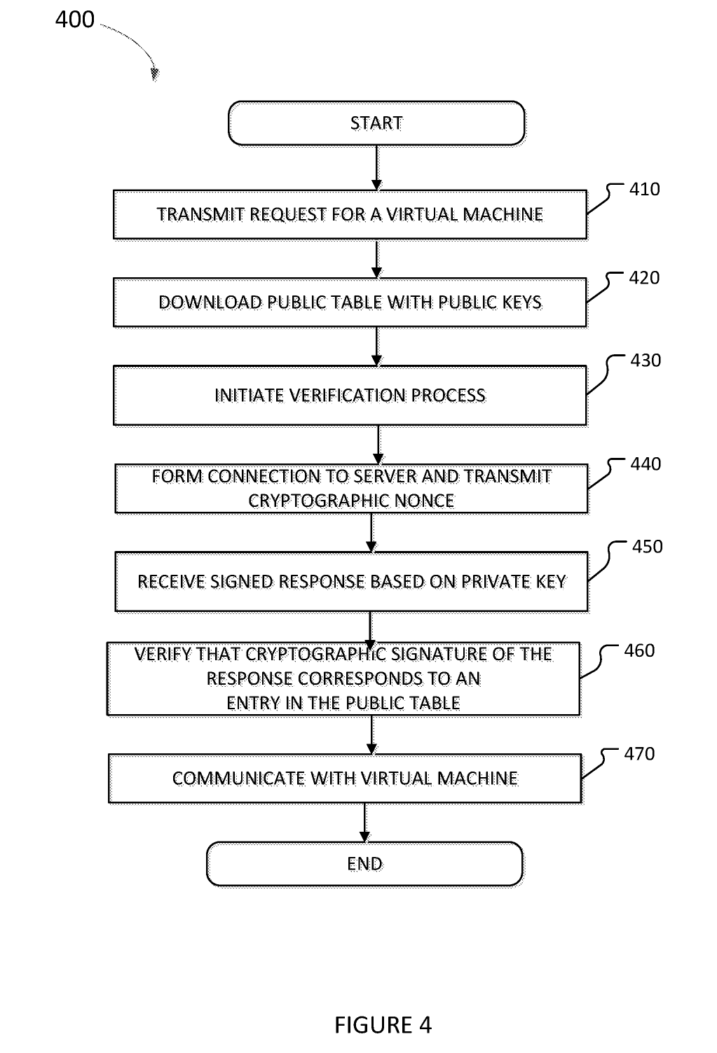

FIG. 4 illustrates a method 400 for assuring integrity and confidentiality of leased computing resources and leased virtual computing resources at one or more central locations, according to an embodiment. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, a client side device may transmit a request for a virtual machine on a server.

At operation 420, a public table with public keys may be accessed, viewed, downloaded by the client side device from the server.

At operation 430, a cryptographic hash on the public table associated the images may be verified by the client side device. In embodiments, the cryptographic hash may be verified by running an application on the client side device that will utilize the public keys within the public table to authenticate the server.

At operation 440, a hardware security module (HSM) verifier associated with the client side device may form a connection to the server, and transmit an attestation request by transmitting a cryptographic nonce. The cryptographic nonce may be random data, such as a string of random characters or a sufficiently large random number to make reuse of an old nonce highly unlikely, generated by the client side device.

At operation 450, the HSM on the server may receive the cryptographic nonce and the cryptographic hash of the firmware from the client side device, and transmit a signed response utilizing the internally stored private key of the HSM to the client side device. As long as the remote computing provider's system associated with the server has not been tampered with, the signed response from the server may validate against the public key listed in the table, the returned firmware hash(es) may match those expected by the client, and/or the system status flags may indicate normal operation

At operation 460, the client side device can verify that that received cryptographic signature of the nonce does correspond to an entry in the public table. This may ensure integrity between the security officers and a user associated with the client side device.

At operation 470, responsive to verifying the image has not been tampered with utilizing the received cryptographic signature, the published public key, the system status flags, and/or the returned cryptographic hash(es), communication between the client and the leased computing resources may be initiated. This process may occur each time sensitive data is edited, or every time a new communication channel is established and/or every time an old communication channel is reconnected

In embodiments, the communication channel by which the leased computing resources may be controlled may be authenticated by one or more HSMs, which may be located remotely. In embodiments, the MTI/TNII may generate a random cryptographic keypair on server start and/or responsive to external stimuli such as a timer expiry or other scheduled or unscheduled event. The public key thus generated may be uploaded into the associated HSM(s) for the purpose of communication channel authentication to the client, thus transferring the root of trust for communication channel authentication into the HSM(s), which are not accessible via a public access area. The private key of this keypair must remain inaccessible to any software and/or hardware outside of the MTI/TNII for security to be maintained.

From a higher level perspective, the HSM(s), by verifying the MTI/TNII as described earlier, also verifies that the random key generator and private key access controls built into the MTI/TNII are secure. Thus, allowing their use to assist in securing the communication channel itself and ensuring that the HSM is sufficient to authenticate both the leased computing resources and the communication channel(s) used to control them.

In embodiments, the client side device may obtain the public key for the communication channel from the associated HSM, and may verify that the HSM provided this public key in the same general manner as the firmware hash verification process described earlier. Alternatively, the firmware hash and communication channel public key may be verified as part of the same process.

In embodiments, the client side device may then verify that the public key of the currently active communication channel matches the verified public key stored within the public access area. In embodiments, the client side device may open a new communication channel for the purpose of accessing the leased computing resources, and the client side device may verify the provided public key from this new connection matches the previously obtained verified public key.

In embodiments, an FPGA-based HSM as described in U.S. provisional patent application U.S. 62/415,965 (which is incorporated by reference herein) may be used in the role of the HSM. In embodiments, the external TPM described in U.S. 62/415,965 may be omitted, integrated into the primary HSM FPGA, or implemented via a second shielded FPGA as dictated by the requirements and/or desired configuration of any particular facility using the present technology and/or the HSM described in U.S. 62/415,965.

In embodiments, the FPGA described in U.S. 62/415,965 may utilize external nonvolatile configuration storage in lieu of potentially available internal nonvolatile storage for the FPGA logical configuration data (also known as a “bitstream”). This external storage is located within the shielded area described in U.S. 62/415,965, and may be accessed from outside the shielded area for purposes of auditing the active FPGA configuration. Furthermore, the external storage is rendered read-only unless a write request is asserted, with an integrity violation and/or FPGA reset asserted responsive to write request assertion. As a result, the external storage may not be modified while the FPGA is active regardless of the uploaded FPGA configuration, with this result being enforced by logic devices placed within the shielded area and external to the FPGA.

In embodiments, the communication channel by which the leased computing resources may be controlled is implemented using standard Secure Shell (SSH) technology.

In embodiments, the MTI/TNII provide a limited list of possible commands that may be executed on the leased computing resources and/or the MTI/TNII itself, responsive to internal and/or external authorization, and will reject any commands not provided on the limited list. This limited command set may include, by way of example, commands to power on or power off the leased computing resources, to reset the MTI/TNII, to obtain the current operating statistics of the leased computing resources and/or the underlying hardware, and to control the operating parameters of the leased computing resources and/or the underlying hardware responsive to proper authentication. It should be understood that this list is neither comprehensive nor required, and that each command in the limited list may be allowed or denied by the MTI/TNII responsive to external, internal, and/or combined external and internal authorization.

In embodiments, individual users of a shared virtual machine host may be allowed control of virtual machines that they have launched by the MTI/TNII, however attempts to command or otherwise access the virtual machines of other users will be denied by the MTI/TNII.

In embodiments, the MTI/TNII may allow or deny any combination of virtual machine control commands responsive to external authorization lists and/or an external authorization system, which may be implemented using a standard query/response system. Queries may include details on the connecting client, and responses may request additional information from the client before providing a response to the MTI/TNII with information on whether to grant or deny access to the requested control command(s).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable content may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for ensuring integrity of shared computing resources, the system comprising:
a computing device that can be remotely accessed with an associated hardware security module;
a public and private key pair associated with the hardware security module, wherein the public and private key pair includes a public key and a private key;
a public key table including the public key associated with the hardware security module, and a cryptographic hash of a secured and trusted image associated with the hardware security module

2. The system of claim 1, wherein the computing device that can be remotely accessed is a server, wherein the server is moved to from an initialization area to a production area after the hardware security module is provisioned with the secured and trusted image.

3. The system of claim 2, wherein an image is stored into nonvolatile storage of the server, and where the hardware security module is configured to access the stored image for verification, wherein the image is a minimally trusted image or a trusted network interface image.

4. The system of claim 1, further comprising:
leased computing resources configured to lease computing resources by a client side device.

5. The system of claim 4, wherein the client side device configured to download the public key, and the cryptographic hash from the public key table, and to generate a cryptographic nonce.

6. The system of claim 5, wherein the hardware security module is configured to generate the private key, and is a field programmable gate array, wherein the hardware security module is located remotely from the client side device.

7. The system of claim 5, wherein the hardware security module is configured to generate a cryptographic signature based on the private key responsive to receiving the cryptographic nonce from the client side device, wherein the hardware security module is configured to attest to the private key via the cryptographic signature, and wherein the hardware security module is validated based on the generated signature and public key.

8. The system of claim 7, wherein the client side device is configured to parse the public table to verify that the cryptographic signature corresponds with an entry in the public key table.

9. The system of claim 8, wherein the client side device is configured to establish a communication channel to the leased computing resources responsive to verifying that the cryptographic signature corresponds with the entry in the public key table and that the response data indicates a normally functioning and trustworthy remote computing environment.

10. The system of claim 1, further comprising:
a trusted hardware module that is configured to store a key pair, the key pair including a first private key and a first public key, wherein the first private key is utilized to establish communication between a client side device and the computing device that can be remotely accessed.

11. A method for ensuring integrity of shared computing resources, the system comprising:
generating a public and private key pair associated with a hardware security module, wherein the public and private key pair includes a public key and a private key;
creating a public key table including the public key and a cryptographic hash of a secured and trusted image associated with the hardware security module, the hardware security module being associated with a computing device that can be remotely accessed.

12. The method of claim 11, further comprising:
moving the computing device that can be remotely accessed from an initialization area to a production area after the hardware security module is provisioned with the secured and trusted image, wherein the computing device that can be remotely accessed is a server,

13. The method of claim 12, further comprising:
storing an image into nonvolatile storage of the server, and
accessing, via the hardware security module, the stored image for verification, wherein the image is a minimally trusted image or a trusted network interface image.

14. The method of claim 11 further comprising:
leasing computing resources associated with the computing device that can be remotely accessed by a client side device.

15. The method of claim 14 further comprising:
downloading, via the client side device, the public key and the cryptographic hash from the public key table; and
generating, via the client side device, a cryptographic nonce.

16. The method of claim 15, further comprising:
generating, via the hardware security module, the private key, the hardware security module being a field programmable gate array, wherein the hardware security module is located remotely from the client side device.

17. The method of claim 11, further comprising:
generating, via the hardware security module, a cryptographic signature based on the private key responsive to receiving the cryptographic nonce from the client side device,
attesting, via the hardware security, to the private key via the cryptographic signature, and
validating the hardware security module based on the generated signature and public key.

18. The method of claim 17, further comprising:
receiving at the client side device the generated signature;
parsing the public table to verify that the cryptographic signature corresponds with an entry in the public key table.

19. The method of claim 18, further comprising:
establishing a communication channel to the leased computing resources responsive to verifying that the cryptographic signature corresponds with the entry in the public key table and that the response data indicates a normally functioning and trustworthy remote computing environment.

20. The method of claim 11, further comprising:
storing on a trusted hardware module a key pair, the key pair including a first private key and a first public key, wherein the first private key is utilized to establish communication between a client side device and the computing device that can be remotely accessed.
